(19) United States
(12) Patent Application Publication
(10) Pub. No.: US 2025/0322348 A1
(43) Pub. Date: Oct. 16, 2025

(54) Computational Methods and Systems for Freight Container Loading Optimization

(71) Applicant: Ethicon, Inc., Raritan, NJ (US)

(72) Inventors: Nitish Umang, Raritan, NJ (US); Thomas Balcavage, Raritan, NJ (US); Jefferson Jee, Raritan, NJ (US); Riddhesh Nitin Kumtakar, Raritan, NJ (US); Prem Raj Dahal, Raritan, NJ (US); Angela Simko, Raritan, NJ (US); James Bode, Raritan, NJ (US)

(21) Appl. No.: 19/176,353

(22) Filed: Apr. 11, 2025

Related U.S. Application Data
(60) Provisional application No. 63/633,205, filed on Apr. 12, 2024.

(51) Int. Cl. G06Q 10/083

(52) U.S. Cl. CPC G06Q 10/083

(57) ABSTRACT

An analytical method to optimize gaylord building and truck loading for outbound container shipments includes defining, within the 3-dimensional physical space, one or more 2-dimensional layers, each 2-dimensional layer having a fixed height. Using one or more heuristic algorithms, for each of the one or more 2-dimensional layers, one or more objects of a plurality of objects can be assigned for placement within the two-dimensional layer, and one or more placement positions within the 2-dimensional layer can be assigned for each of the one or more of the plurality of objects. The assigned placement positions can be displayed, reported, or otherwise transmitted to a user or system.

### CROSS-REFERENCE TO RELATED APPLICATIONS

This application claims the benefit of U.S. Provisional Application 63/633,205 filed on Apr. 12, 2024. The content of this application is incorporated by reference herein.

### BACKGROUND

The logistics of container loading, that is, the placing and packing of goods for shipping and transport, is an essential consideration in domestic and global trade. Efficient management of container loading typically involves efforts to maximize space utilization during transit. The problem of optimizing space to load a maximum quantity of packed product onto a pallet is sometimes referred to as the pallet loading problem (PLP), or, in the 2-D or 3-D space, as the container loading problem. Current methods for freight container loading are inefficient, often relying heavily on spreadsheets and manual calculations, and may otherwise be limited by the loader's personal experience. While some studies have attempted to solve the 3-D container loading problem using computational heuristic methods, existing methods are often computationally expensive. Excessive use of CPU time can be prohibitively time-consuming and/or expensive for daily operational planning use.

Accordingly, further techniques for the optimization of container loading are generally desired.

### SUMMARY

Methods and systems directed to analytics to optimize gaylord building and truck loading for outbound container shipments are set forth in the accompanying drawings and description below.

Such systems and methods may variously include one of more of the following features. Generating loading assignment placement positions may include defining within a 3-dimensional physical space, one or more 2-dimensional layers, each 2-dimensional layer having a fixed height. For each of the one or more 2-dimensional layers, one or more objects of a plurality of objects may be assigned for placement within the two-dimensional layer. One or more placement positions may be assigned within the 2-dimensional layer for each of the one or more of the plurality of objects. Both of the foregoing assignments may be performed using one or more heuristic algorithms. The assigned placement positions may be transmitted to a user.

In some embodiments, a method of determining respective placements for a plurality of objects within a 3-dimensional physical space may comprise obtaining, for each of the plurality of objects, (a) a height, (b) a weight, and (c) an indication of whether the object may be stacked. The method may further comprise assigning one or more objects of the plurality of objects for placement within a 2-dimensional layer having a fixed height. The method may further comprise assigning, via one or more mathematical calculations, a placement position within the 2-dimensional layer for each of the one or more objects of the plurality of objects, the one or more mathematical calculations being configured to: (i) maximize the number of objects of the plurality of objects than can be placed within the 2-dimensional layer, weighted by the area of the objects, and (ii) if the height of the objects with assigned placement positions is less than the fixed height, select additional unassigned objects of the plurality of objects for placement within the 2-dimensional layer and assign, for each additional unassigned object, a placement position within the 2-dimensional layer. The 3-dimensional physical space may be a gaylord.

The indication of whether the object may be stacked may be one or more of the following: a product category, a product type, a stock keeping unit (SKU), and a universal product code (UPC). For an object of the plurality of objects, one or more of the height, the weight, and the indication of whether the object may be stacked may be determined based on one or more of the following: a product category, a product type, a stock keeping unit (SKU), and a universal product code (UPC). The one or more objects of the plurality of objects may be cuboid in shape. The one or more mathematical calculations may comprise a mathheuristic algorithm. For an object of the plurality of objects, one or more of the height, the weight, and the indication of whether the object may be stacked may be determined based on data obtained, via a data pipeline, from one or more warehouse management systems. The data pipeline may be dedicated to the transfer of data relating to the plurality of objects, wherein the data relating to the plurality of objects comprises one or more of the following: product category, product type, stock keeping unit (SKU), and universal product code (UPC).

In some embodiments, a method of determining respective placements for one or more objects within a 3-dimensional physical space may comprise obtaining, for each of the plurality of objects, (a) a height, (b) a weight, and (c) an indication of whether the object may be stacked. The method may further comprise assigning, via one or more optimization algorithms, the one or more objects for placement within the 3-dimensional physical space, the assigning comprising (i) defining, within the 3-dimensional physical space, one or more 2-dimensional layers, each 2-dimensional layer having a fixed height, and (ii) assigning one or more objects of the plurality of objects to placement positions within each 2-dimensional layer, wherein the one or more optimization algorithms are configured to minimize the number of 2-dimensional layers within the 3-dimensional physical space and/or minimize the number of placement positions within a 2-dimensional layer. At least one of one or more objects for placement within the 3-dimensional physical space may be a gaylord. Each of the 2-dimensional layers may be a discrete 3-dimensional space within the cargo space of the truck. The one or more optimization algorithms may comprise a mathheuristic algorithm.

In some embodiments, a method of determining respective placements for each of a plurality of objects within a 3-dimensional container space may comprise obtaining, for each of the plurality of objects, (a) a height, (b) a weight, and (c) an indication of whether the object may be stacked. The method may further comprise defining, within the three-dimensional container space, a plurality of positions. The method may further comprise, for each of the plurality of positions, assigning one or more objects of a plurality of objects for placement at the position using one or more heuristic algorithms configured to maximize the number of objects of the plurality of objects than can be placed within the 3-dimensional container space weighted by the area of the objects. The 3-dimensional container space may have a fixed height, a fixed width, and a fixed length. The 3-dimensional container space may be the cargo space of a truck. The 3-dimensional container space may have a fixed height. The 3-dimensional container space may be defined by a coordinate grid. Each of the plurality of positions may comprise at least one set of coordinates defining a discrete 3-dimensional space within the cargo space of the truck.

In some embodiments, any of the foregoing features may be implemented via instructions executed within or otherwise initiated by a computer system for determining respective placements for a plurality of objects within a 3-dimensional physical space.

In some embodiments, any of the foregoing features may be implemented via instructions executed within or otherwise initiated by a computer system for calculating a maximum number of objects that can be placed within a 3-dimensional physical space.

In some embodiments, any of the foregoing features may be implemented via instructions executed within or otherwise initiated by a computer system for determining a placement of objects within a physical space defined by a 2-dimensional grid.

In some embodiments, any of the foregoing features may be implemented via instructions executed within or otherwise initiated by a computer system comprising a first module configured to define, within a 3-dimensional physical space, one or more 2-dimensional layers, each 2-dimensional layer having a respective height; and a second module configured to, for each of the 2-dimensional layers, (a) assign one or more objects of the plurality of objects for placement within the 2-dimensional layer and (b) assign one or more placement positions within the two-dimensional layer for each of the one or more of the plurality of objects, using one or more heuristic algorithms.

In some embodiments, any of the foregoing features may be implemented via instructions executed within or otherwise initiated by a computer system comprising one or more neural networks configured to: define, within a 3-dimensional physical space, one or more 2-dimensional layers, each 2-dimensional layer having a respective height; and for each of the 2-dimensional layers, (a) assign one or more objects of the plurality of objects for placement within the 2-dimensional layer, and (b) assign one or more placement positions within the 2-dimensional layer for each of the one or more of the plurality of objects.

Any of the systems and methods described herein may be configured to display or may otherwise comprise displaying the assigned placement positions to a user via a screen or a report.

In some embodiments, a method of determining an arrangement of a plurality of objects within a 3-dimensional physical space with a fixed height may comprise obtaining, for each of the plurality of objects, (a) a height, (b) a weight, and (c) an indication of whether the object may be stacked. The method may further comprise generating a virtual loading plan for the 3-dimensional physical space by: (a) generating a virtual loading layer within the 3-dimensional physical space, the loading layer (i) being comprised of one or more picks, each pick being an object of the plurality of objects, (ii) having a height that is less than the fixed height, and (iii) being generated via one or more integer programming optimization models and/or heuristics, while accounting for a pick dimension and a pick orientation, (b) calculating a total height of the virtual loading layer in combination with a combined height of all other virtual loading layers within the virtual loading plan, (c) if the calculated total height does not exceed the fixed height, (1) adding the generated virtual loading layer to the virtual loading plan, and (2) repeating items (a)-(c), and (d) creating the virtual loading plan by stacking all generated virtual loading layers, wherein each pick is cuboidal in shape.

In some embodiments, a method of determining an arrangement of a plurality of objects within one or more 3-dimensional physical spaces, each 3-dimensional physical space having a respective fixed height may comprise, for each 3-dimensional physical space of the one or more 3-dimensional physical spaces, (a) defining a plurality of loading layers that can be stacked within the 3-dimensional space, wherein each loading layer comprises one or more picks, and wherein each pick is an object of the plurality of objects, (b) assigning, to each loading layer of the plurality of loading layers, an arrangement of picks to be placed in the loading layer, wherein the assigning is performed by applying one or more integer programming optimization models and/or heuristic functions, while accounting for, for each pick within the arrangement of picks, at least one pick dimension and at least one pick orientation, and (c) stacking the plurality of loading layers to build a virtual loading plan defining an arrangement of the plurality of objects within the 3-dimensional space. Each pick may be cuboidal in shape. Each pick may correlate with a product stock keeping unit (SKU). A 3-dimensional physical space may be a gaylord. The arrangement may be a positional arrangement. The method may further comprise obtaining, for each of the plurality of objects, one or more of: a product category, a product type, a stock keeping unit (SKU), and a universal product code (UPC). The method may further comprise obtaining, for each of the plurality of objects, one or more of: (a) a height, (b) a weight, and (c) an indication of whether the object may be stacked.

In some embodiments, a method of projecting, based on a plurality of objects, a number of physical containers needed to transport the plurality of objects may comprise determining an arrangement of the plurality of objects to be placed within or upon one or more physical containers, each physical container having a fixed height, wherein the determining comprises iteratively performing the following steps until all objects of the plurality of objects have been assigned to a stacking position within the one or more physical containers: (a) selecting, in accordance with one or more integer programming optimization models and/or heuristic functions, whether additional objects should be added to a first physical container of the one or more physical containers or to another physical container of the one or more physical containers, and (b) assigning each object of a subset of the plurality of objects, in accordance with the selecting, a stacking position within or upon a physical container, wherein the assigning is performed by applying one or more integer programming optimization models and/or heuristic functions that account for one or more of: a pick dimension, a pick orientation, a pick height, a pick weight, a pick categorization. The method may further comprise generating, based on the determined arrangement of the plurality of objects, one or more virtual loading plans for at least one of the one or more physical containers. The physical containers may be gaylords and each gaylord may have its own set of dimensions. The method may further comprise determining, based on the loading plan(s), a number of gaylords needed to transport the plurality of objects. The method may further comprise determining, based on the virtual loading plan(s), a number of trucks needed to transport the plurality of objects. The arrangement of the plurality of objects may be further determined in accordance with, for each object of the plurality of objects: a product volume, a product weight, and/or a determination of whether the product has a product type to which one or more specialized rules must be applied. The arrangement of the plurality of objects may be further determined to minimize the number of total stacking positions. The arrangement of the plurality of objects may be further determined to minimize the number of total stacking positions by, in the selecting, applying an integer programming optimization model that uses stacking rules related to one or more of: gaylord height, gaylord weight, and special restrictions on the objects.

The physical containers may be trucks. The method may further comprise projecting a number of trucks needed to transport the plurality objects in accordance with one or more of: an object volume, an object weight, and special restrictions on the objects.

Where the physical containers are gaylords, the method may further comprise projecting a number of trucks needed to transport the gaylords in accordance with one or more of: gaylord height, gaylord weight, stacking rules related to objects placed within or upon the gaylord.

### BRIEF DESCRIPTION OF THE DRAWINGS

The disclosed embodiments have advantages and features that will be more readily apparent from the detailed description, the appended claims, and the accompanying figures (or drawings). The disclosure can be better understood with reference to the following drawings. The elements of the drawings are not necessarily to scale relative to each other, emphasis instead being placed upon clearly illustrating the principles of the disclosure.

FIG. 1 is a block diagram depicting an exemplary network architecture for a loading optimization system in accordance with the present disclosure.

FIG. 2 is a flowchart depicting an exemplary process for loading optimization in accordance with the present disclosure.

FIG. 3A is a block diagram depicting an exemplary embodiment of a loading optimization system in accordance with the present disclosure.

FIG. 3B is a diagram depicting an exemplary process performed by a loading optimization system in accordance with the present disclosure.

FIG. 4 is a diagram depicting an exemplary process for loading optimization in accordance with the present disclosure.

FIGS. 5A and 5B are diagrams depicting exemplary configurations of picks to be considered in an exemplary process for loading optimization in accordance with the present disclosure.

FIG. 6 is a diagram depicting an exemplary layout configuration to be considered in an exemplary process for loading optimization in accordance with the present disclosure.

FIG. 7 is a block diagram depicting an exemplary architecture for a loading optimization system in accordance with the present disclosure.

In the figures, the left-most digit(s) of a reference number identifies the figure in which the reference number first appears. The use of the same reference numbers in different figures indicates similar or identical items or features. Moreover, multiple instances of the same part are designated by a common prefix separated from the instance number by a dash. The drawings are not to scale.

### DETAILED DESCRIPTION

The present disclosure generally pertains to computer-based technology for optimizing the layout and loading of physical objects in a three-dimensional space.

Companies must often maintain complex distribution networks to meet domestic and international demand for products. In large operations, tens or hundreds of thousands of products may be shipped daily. Given the scale of the task, efficiency is critical to the process of logistics sorting, packaging, and loading. Optimization of the process may include attempts to reduce the number of shipping containers, increase the actual to chargeable weight ratio (more densely packed gaylord, such that the chargeable weight (or volumetric weight) needed to move the same weight is reduced), and decrease the time involved in the creation and execution of a logistics plan. Additionally, it is often desirable to develop efficient loading plans and minimize the number of gaylords (cardboard outer containers that sit on wooden pallets and house product(s) being shipped, also referred to herein as pallets) and trucks (e.g., 53-foot or other large trucks used to transport gaylords to a destination and/or to airfields, where they can be loaded into cargo planes) needed to load outbound shipments. This reduces transportation costs (including fuel cost and CO2 emissions), relieves port congestion, and thereby alleviates pressures on the supply chain, facilitating smoother, timelier, and more cost-efficient flow of products from the manufacturer to the end user.

Because both per-pallet and per-shipment charges are assessed by carriers, logistics plans that reduce the number of gaylords and/or trucks needed to transport the same amount of product are preferred. Further, for products that have high physical volume relative to their weight (e.g., medical products), this approach also minimizes the total chargeable weight (a proxy conversion used for weight in situations where volume is greater than actual weight) carriers use to assess “per-kilogram” charges. A lower number of gaylords and trucks and/or an overall higher actual to chargeable weight ratio will in turn also take less time and/or personnel (whether manpower or machine) to process and load, further improving efficiency and reducing cost. One having skill in the art will understand that while the terms gaylord, pallet, truck, shipment, and the like are used herein, these terms may be interchanged with other standardized measurements or modalities, in accordance with logistics industry standards.

In a common scenario involving long distance (e.g., international) shipment, although there may be many individual customers in various locations or countries placing orders, the orders are consolidated and shipped together before being distributed to the end customer once they reach their destination. In such a scenario, one approach is to wait until sufficient orders and product accumulate before loading and shipping, so as to take up the highest possible proportion of the physical space and weight allowances for each gaylord or pallet as well as for each shipment (which may be any defined cargo space, e.g., a truck, a shipping container, a cargo ship or plane). However, a solely cost-focused approach may not be practical for a variety of reasons. A company may, due to a critical nature of a product, need to deliver product as quickly as possible to the end user. Additionally or alternatively, the shipment of product may be limited by inventory constraints. Either of these factors may impact the ability to hold and wait for a fuller shipment.

A balanced approach of the above-mentioned considerations, as described further herein, is to optimize consolidation of products bound for the same destination without delaying the overall flow of orders and shipments.

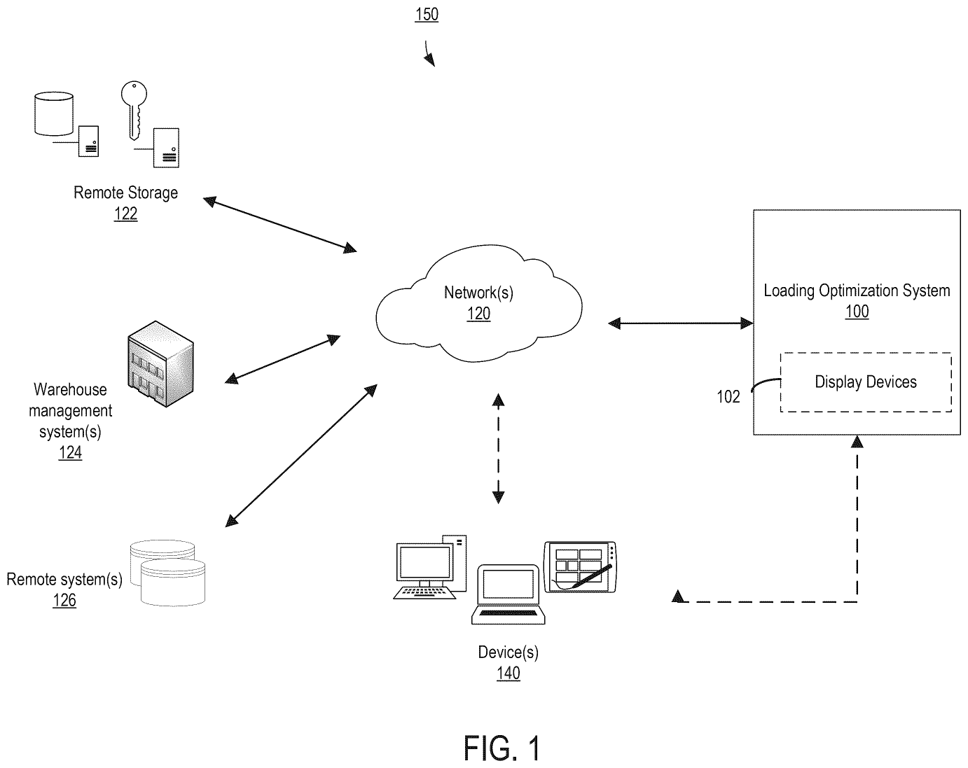

FIG. 1 depicts, in accordance with some embodiments of the present disclosure, an environment 150 including a loading optimization system 100. Loading optimization system 100 is configured to provide, to a user(s) of a device(s) 140, a decision-aid tool that develops (or otherwise generates or selects) space-efficient 3 (three)-dimensional (3D) load plans for the loading of one or more shipping containers.

As illustrated, environment 150 may include one or more business end users of the system 100. The users may be any one or more personnel at a company originating a shipment, a loading facility, a plant or warehouse, an intermediate shipper or distributor, or any other person or entity involved in planning or executing a loading process. Device(s) 140 may be any device capable of displaying or transmitting information to a user, including without limitation a desktop computer, mobile computing device such as a cellular telephone, PDA, tablet, laptop computer, handheld peripheral device, or any network-enabled or otherwise remotely controlled display, screen, projector, printer, or the like. In an exemplary embodiment, the device 140 presents information to a user via a display on or connected to the device, and takes input from the user (e.g., to initiate a process to generate or transmit loading instructions from system 100, or to view outputs of such a process) in relation thereto via a touchscreen, mouse, keyboard, stylus, or any other appropriate input device. Device(s) 140 is communicatively coupled to loading optimization system 100 via one or more networks 120 or directly via a wired or wireless communication link.

In an alternate embodiment, system 100 may be implemented in a local server (e.g., a standard server) that includes one or more display devices 102. These display devices may take the place of device(s) 140, such that the end users would interact with system 100 via display devices 102. In such an embodiment, display device 102 may be implemented in any manner as described above with reference to device 140.

As illustrated, environment 150 may also include one or more remote storage(s) 122 communicatively coupled to loading optimization system 100 via network 120. Remote storage 122 may be a storage owned and/or operated by the company and may be accessible via a public network and/or through a secured intranet or private network. While storage 122 is referred to as “remote” such term is merely exemplary and in some implementations storage 122 may be local to loading optimization system 100, whether geographically so as to be physically connected with system 100 and/or over a local network.

Loading optimization system 100 may additionally communicate with one or more warehouse management systems(s) 124, for instance the MARC (Materials and Resource Control) Warehouse Management System or similar. One of ordinary skill in the art will understand warehouse management system to refer to any software system (whether locally or remotely managed by the end user) that manages warehouse operations including without limitation any of receiving, storage, picking, packing, shipping, supply chain, and/or inventory tracking. In one embodiment, the warehouse management system is a specialized computer system to manage storage and retrieval of inventory at a warehousing and/or loading facility and is capable of interfacing with devices and components within the facility. Such devices may include, for example, forklifts, sensors or sensor systems, camera systems, AI and/or optical systems, HVAC systems, lighting systems, computer systems, automated or manual pick-and-place devices or other machines or loaders, and the like.

System 100 may additionally communicate with any other required remote systems 126 via network 120. Without limitation, a remote system 126 can be any server and/or entity capable of communication over network 120 so as to provide and/or receive data, software, status/notifications/alerts, updates, or other information or communication to or from loading optimization system 100. As just one example for purposes of illustration, remote system 126 may be any of a remote company system providing updated or historic inventory information and/or receiving shipping information after completion of loading/shipment, a third party warehouse or distributor providing inventory information, a retail system, a customer system providing a new or updated order, or any other relevant source or destination of information for loading optimization system 100.

It will be understood that while, for ease of illustration, FIG. 1 depicts several devices 140, one loading optimization system 100, one remote storage 122, one warehouse management system 124, and one third party system 126, environment 150 is not limited to such a configuration. In various implementations, any number of servers, devices, or entities may be present in any number or type of configurations.

The components of environment 150 may communicate with each other over one or more communication network(s) 120. Although communication network 120 may be any suitable communication network, in one embodiment, communication network 120 is the Internet and information may be communicated in an encrypted format such as by a transport layer security (TLS) or secure socket layer (SSL) protocol, or in a non-encrypted format. In addition, when the network 120 is the Internet, any of the components of environment 100 may use the transmission control protocol/Internet protocol (TCP/IP) for communication.

In the exemplary embodiments, loading optimization system 100 determines and provides to end users information sufficient to convey a suggested (that is, a desirable and/or in some cases, optimal or nearing optimal) arrangement and sequencing of objects (picks, products, gaylord, pallets, etc.) for placement into 3-dimensional space such as containers (gaylords, trucks, cargo containers, etc.). This determination can be performed with a compute time that is practical to the performance of regular (e.g., daily) loading and shipping operations, while retaining accuracy of results. In an exemplary implementation, the determination is performed within several seconds, though no particular time limit need be implemented. System 100's determination, as described further herein, can be performed in coordination with any or all the operational and technical constraints specified by the business end users or otherwise by the entity managing the loading optimization system 100. The system 100 facilitates the execution of one or more algorithms based on integer programming (IP) and/or rule-based heuristics, described further herein, to provide an automated platform for data ingestion and output visualization.

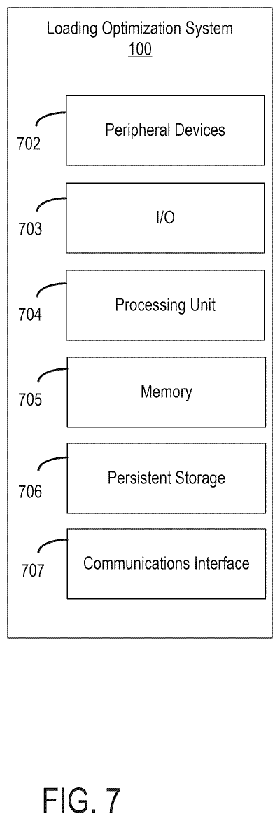

Loading optimization system 100 may be implemented in a number of different forms, such as, without limitation, as a standard server, in a group of such servers (i.e., with multiple instances), in a virtual machine or instance, as part of a rack server system, in a cloud configuration, in a personal computer such as a laptop computer, mobile device, or distributed or any of the above or any one or more computing devices or systems in communication with each other. With reference to FIG. 7, system 100 includes a processing unit 704, memory 705, persistent storage 706, an input/output device such as a display 703, and a communication interface 707, among other components. Each of the components are interconnected using various buses, and several of the components may be mounted on a common motherboard or in other manners as appropriate.

The processing unit 704 can execute instructions within the system 100, including instructions stored in the memory 705 and/or persistent storage 706. The processing unit includes any of (or any combination of) central processing unit (CPU), graphics processing unit (GPU), digital signal processor (DSP), application specific integrated circuits (ASICs), radio-frequency integrated circuits (RFICs), other specialized processor or combination of processors, or other circuitry that communicates to and drives the other elements. While FIG. 7 illustrates one processor 704 which implements all of the various logics in the loading optimization system 100, it is possible in other embodiments for the system 100 to employ multiple processors.

The memory 705 stores information and instructions within the system 100. The memory 705 can be implemented as one or more of a computer-readable medium or media, a volatile memory unit or units, or a non-volatile memory unit or units. Memory 705 may refer to any suitable storage medium, either volatile and non-volatile (e.g., RAM, ROM, EPROM, EEPROM, SRAM, flash memory, disks or optical storage, magnetic storage, or any other tangible or non-transitory medium), that stores information that is accessible by processor 704. In some embodiments, memory 705 may include one or more secured components to store sensitive data.

System 100 is configured to generate an assignment of picks (e.g., rectangular boxes) for placement on gaylords (containers) and an assignment to stack gaylords on trucks for outbound container shipments. The assignments may take the form of a spreadsheet or layout diagram. The assignment may also be understood as a virtual loading plan (for a 3-dimensional space or a virtual loading layer) or virtual stacking plan, though it is representative of a true/extant (in some instances tangible) physical space.

Products are typically packed in standard ways, such that the same product (identifiable, e.g., by a stock keeping unit (SKU), universal product code (UPC), product number, product category, product type, and/or other identifier for inventory management) will be packaged (whether individually or in bulk) in a package or container for which the size and weight is known to one or more of the originating company, the shipper, the distributor, and other entities involved in the process. In the present disclosure, the term “pick” is generally used, though it may alternately be referred to as a product, object, gaylord/pallet, or item, or the like. In an exemplary embodiment, a pick is a cuboid/rectangular box of predetermined or known or measurable dimensions in a 3-dimensional space. Each product SKU (or other unique identifier) conforms to a unique and consistent set of pick dimensions. A shipment can be generally understood as including a large number of picks, though this disclosure applies to any number with no maximum or minimum except those defined by practicality (e.g., greater than zero). A shipment may be understood to include one or a variety of product SKUs, but in an exemplary embodiment, multiple product SKUs are included and therefore a level of heterogeneity exists in the product mix. As such, complexity is introduced into the generation of a pick-to-gaylord assignment. Optimization of this assignment will be understood by one of skill in the art to be an NP-hard optimization problem.

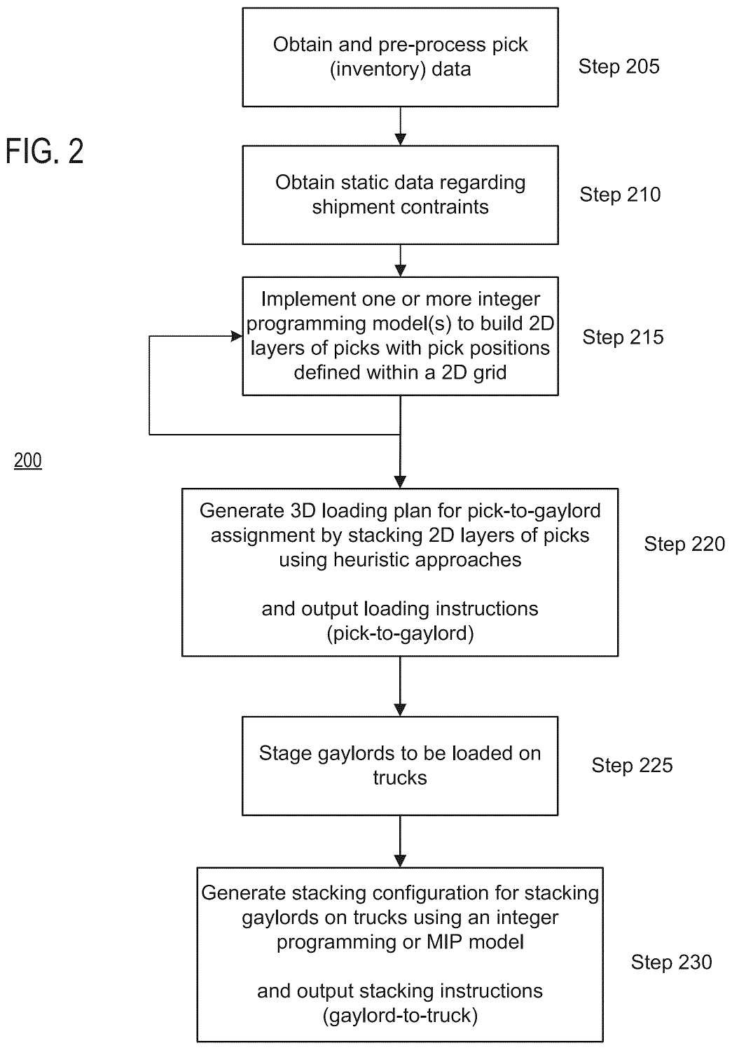

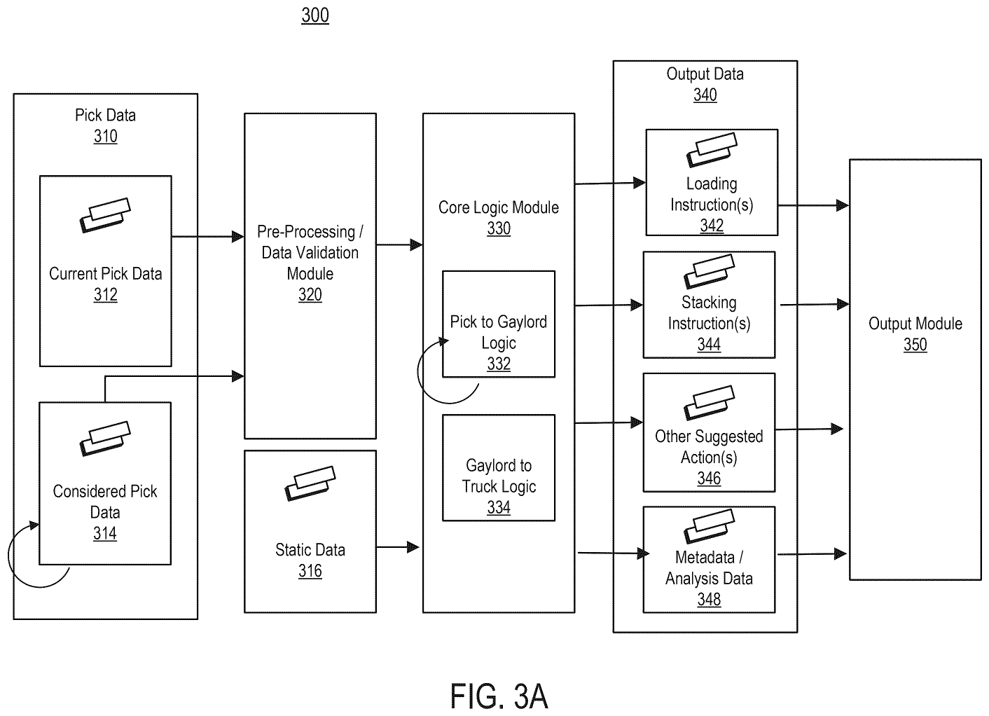

The operation of an exemplary embodiment of the loading optimization system 100 is described herein with reference to FIG. 2. FIG. 2 depicts an exemplary process 200 by which loading optimization system 100 may provide loading instructions to end users based on inventory and shipping constraint information. In Step 205, system 100 receives pick data from one or more remote systems, e.g., a warehouse management system 124. In Step 210, system 100 receives static data defining shipment constraints relevant to the loading plan. This pick data and static data is described in greater detail below with reference to FIG. 3A.

In Step 215, one or more integer programming models is iteratively called for building 2D layers of picks and heuristic-based logic is applied to assign more cases in the void spaces between successive layers. To avoid issues related to scaling and intractability, the integer programming model is made more compact and efficient by using grid construction techniques that define the 2D grid based on the superimposition of the linear combinations of a subset of product SKUs. In Step 220, a 3D loading plan for pick-to-gaylord assignment is generated (or otherwise created or built) by stacking the optimized 2D layers of picks using one or more heuristic approaches. The pick-to-gaylord loading instructions are output to the end user (e.g., 2D and/or 3D virtual load plan). In Step 225, the gaylords are staged to be loaded on trucks. In Step 230, another integer programming model(s) is applied to determine an optimized (or otherwise desirable or “best” achievable) stacking configuration of gaylords on trucks within the bounds of practicality. While, in the exemplary embodiments, separate models are applied in Steps 215 and 230, additional or alternate embodiments may exist where both steps are facilitated by applying single model or a plurality of models in any combination. In Step 230, gaylord-to-truck stacking instructions are output to the end user. It will be understood that the output in Steps 220 and 230 is not limited to any particular form or format and any type of transmission appropriate to the configuration of system 100 and environment 150 may be used.

FIG. 3A depicts an exemplary configuration 300 of loading optimization system 100 for implementation of the process flow described above with reference to FIG. 2.

Static data 316 includes without limitation gaylord, pallet, and/or truck information and attributes, as well as business constraints or rules relevant to the generation of a loading plan. In an exemplary embodiment, static data 316 may be obtained in advance of the execution of any logic (module 330) from plant/warehouse/shipping managers, and/or other subject matter experts. Static data 316 may be infrequently updated (e.g., monthly or every several months, though any time constraint may be applied) or more regularly/frequently updated according to business conditions.

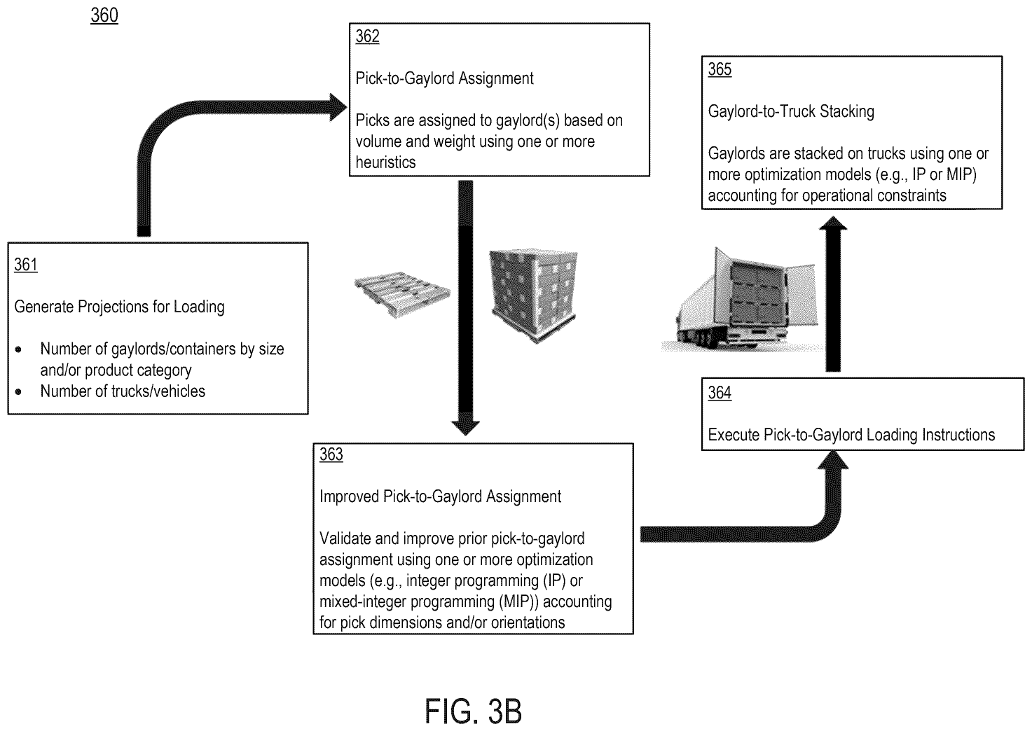

Pick data 310 is considered dynamic data and may be sourced (or otherwise obtained) in real-time or shortly before the application of core logic module 330. In an exemplary embodiment, pick data 310 is obtained from a warehouse management system 124, remote storage 122, and/or any local storage or system memory within or communicatively coupled to system 100. Pick data 310 may include customer orders and real-time status of picks as they are being scanned and processed in the warehouse or loading facility. In some embodiments, pick data 310 is obtained through one or more automated data pipelines and is refreshed in relatively short intervals (e.g., on an hourly basis or less, or otherwise in real-time or near real-time). In another embodiment, some or all of pick data 310 may be additionally or alternately obtained by scanning the picks at the local or remote warehouse or loading facility (e.g., scanning a bar code or QR code or other machine readable information on the physical object) and transmitting the information to system 100 either as a complete dataset or in pieces/serially such that system 100 compiles a set of pick data in a local storage/memory. Pick data may be stored in memory 705 and used during implementation of the loading optimization process described herein with reference to FIGS. 3A, 3B, and 4.

Pick data 310 includes at least current pick data 312 and considered pick data 314. Current pick data 312 may be understood as pick information relating to the daily operational table, that is, the inventory to be shipped on a given day. Current pick data 312 may include without limitation all picks from that day (e.g., “today”, in the context of when process 200 is being executed) and/or in a recent given time period (e.g., last 72 hours, last 48 hours, last week, or so on). Current pick data 312 includes in an exemplary embodiment pick SKUs, pick quantities (e.g., for each respective SKU), pick dimensions (e.g., for each respective SKU), pick status, last update information (as timestamp or similar data), customer information and destination information (also referred to as “lane” information), among other relevant information. While the term SKU is used here, any identifier for the pick may be applied analogously. Current pick data 312 may include an indication of whether or not the object (the pick) may be stacked, or whether there are constraints on the stacking of the pick (or a portion of the pick), such as stacking orientation or fragility/tolerable weight. Current pick data 312 may include information for one or more of any SKUs, customers, destinations and so on. In one embodiment, each pick is assigned a unique identifier, and other information (e.g., SKU, dimensions, update, customer, destination, etc.) is provided in association with that unique pick ID. In other embodiments, another type of information may act as the unique delimiter of the inventory information, such as SKU or destination, so long as a unique identifier can be provided so as to associate related information. Considered pick data 314 may be understood as information identifying already considered picks vs. unassigned picks. The information contained in considered pick data 314 may be understood as analogous to that described above with reference to current pick data 312, but considered pick data 314 includes data captured after each execution (run) of the pick-to-gaylord logic 332 executed by core logic module 330 (described further below). This considered pick data 314 is leveraged to remove picks assigned in prior runs from subsequent outputs, so that an accurate inventory of remaining picks is available for consideration. Considered pick data 314 is therefore iteratively updated for accurate consideration in subsequent algorithmic iterations performed in the generation of pick position layouts. In an alternate embodiment, rather than already-considered pick data, unassigned pick data may be separately tracked.

Pick data 310 may in some embodiments be obtained as raw data, necessitating data validation and/or pre-processing of the pick data 310 by module 320 before being ingested into logic module 330. This pre-processing ensures the accuracy, consistency, and quality of data obtained, particularly where data is being collected in a raw format and/or from an external source. In some embodiments, module 320 may infer or calculate data that is desired or favorable for the application of loading optimization processes but is absent or missing from the data. For instance, in some embodiments, at least the dimensions and weight of each pick should be known for the accurate implementation of the loading optimization process. In a scenario where an element(s) of this information is missing for one or more picks, module 320 may apply data re-creation or inferential techniques (e.g., using analogous data within pick data 310, historic pick data, business operation rules, defaults, and so on) to infer such information so as to generate sufficient input data for core logic module 330.

Core logic module 330 takes in the processed pick data from pre-processing/data validation module 320 and the static data 316. Core logic module 330 applies operational logic to apply one or more solvers to perform logical calculations. In general, one having skill in the art will understand that any of a variety of solvers (whether commercial or specially created) can be applied to optimize for a variety of given goals (e.g., business constraints, minimum number of gaylords, minimum number of trucks, chargeable weight ratio, and so on) within the framework for application of core logic module 330 described herein and below. In alternate embodiments, one or more neural networks may be utilized to perform all or part of the operations executed by core logic module 330 through the application of one or more specially trained machine learning models (e.g., trained off of historical pick data 310), however it will be generally understood that optimization solutions are often more practical in terms of solution feasibility, accuracy, and time efficiency, as described in greater detail herein and below with reference to FIGS. 1-7.

The various logics of core logic module 330 may be executed in a variety of ways, e.g., on a dedicated or shared server, a virtual machine, local machine, etc. Implementation may be initiated via one or more APIs or via a web-based form or interface, so as to be implemented as requested by personnel at a company or plant/warehouse facility. Operational logic of module 330 may be implemented as Python code or any other appropriate coding language and architecture. Any additional computational tools, e.g., solvers, may be run in the same or an alternate environment in a manner appropriate to optimize computing efficiency. Core logic module 330 may be called (that is, initiated) on an ad hoc basis and/or at scheduled times whether recurring/timed or individually scheduled. In an exemplary embodiment, core logic module 330 applies at least one of its components (described in greater detail below) at multiple scheduled times in a given business period (e.g., multiple predetermined times per business day).

Core logic module 330 is comprised of at least two discrete logics. Pick-to-gaylord logic 332 is applied iteratively to assign, for each of the picks in current pick data 312, each respective pick to a projected gaylord using rule-based heuristics. The iteration(s) of pick-to-gaylord logic 332 is continued (that is, the logic is re-run) until no unassigned picks remain. Pick-to-gaylord logic 332 considers multiple picks in each run, considering a different plurality of picks in each iterative execution. The output of pick-to-gaylord logic 332 is, at minimum, loading instructions 342. The process initiated by pick-to-gaylord logic 332 is described further below with reference to FIGS. 3B and 4. Gaylord-to-truck logic 334 is applied after the completion of all iterations of pick-to-gaylord logic 332. Gaylord-to-truck logic 334 may be applied iteratively or in one run to generate assignments for gaylord-to-truck stacking. The output of gaylord-to-truck logic 334 is, at minimum, stacking instructions 344. The process initiated by gaylord-to-truck logic 334 is described further with reference to FIG. 3B.

Output data 340 includes at least loading instructions 342 and stacking instructions 344. In some embodiments, core logic module 330 may contain additional logic to generate, in addition to loading and stacking instructions, additional or alternate instructions reflecting other suggested actions 346. Other suggested actions may include, for example, information about additional or unexpected constraints relevant to the loading and/or stacking of any object. This may include, for example, information relevant to stacking (e.g., orientation or weight limits), restrictions on change to the loading plan (e.g., where the personnel cannot deviate for structural, business, or safety reasons), restrictions on timing of shipment, explanatory information for instructions deviating from the norm (e.g., where pallets are left less full due to business constraints), customer instructions or special requests, explanatory information regarding instructions (e.g., alternately formatted results), instructions presented in a different format or modality (e.g., so as to be comprehensive to a machine in an automated facility), and so on. In some embodiments, core logic module 330 may additionally or alternately output metadata and/or analysis data 348. This is data regarding the loading optimization process that may be relevant to the user. Without limitation, such metadata or analytical output may include summary data and/or troubleshooting information relating to the performance of core logic module 330, information reflective of trends or inferences made regarding generated loading and/or stacking instructions, information reflective of trends or inferences regarding the quantity and/or type of picks, and so on.

The loading instructions 342 and stacking instructions 344 reflect assignments for positioning objects with the 3-dimensional space. The 3-dimensional space has any or all of a fixed height, fixed width and/or fixed length. In the case of the loading instructions 342, the 3-dimensional space may be a gaylord/pallet. In the case of the stacking instructions 344, the 3-dimensional space may be the cargo space of a truck and/or shipping container. The 3-dimensional space is defined by a coordinate grid, so as to refer to positions for objects defined by respective sets of coordinates within the grid.

Output module 350 transmits at least the generated loading instructions 342 (pick-to-gaylord loading instructions) and stacking instructions 344 (gaylord-to-truck stacking instructions) to the end user. In some embodiments, the output module 350 may, either automatically or at the request of a user, provide any or all of any generated other suggested actions 346 and/or metadata or analysis data 348. Loading instructions 342 and stacking instructions 344 (separately or collectively also referred to herein as a load plan or loading plan) may take a variety of forms, such as a human readable diagram or spreadsheet, a set of coordinates or information sufficient to describe position, a listing of otherwise formatting position information, instructions in a format understandable for a machine (e.g., forklift or object mover) configured to pick and move items or pallets, or the like. In an exemplary embodiment, a load plan is provided to an end user in a downloadable file format (e.g., a spreadsheet/Microsoft Excel file, dataset, etc.), however it may additionally or alternatively be made available via a screen display or printed or transmitted in a report. It will be understood that the output is not limited to any particular form or format any type of transmission appropriate to the configuration of system 100 and environment 150 may be selected. In an alternate embodiment, rather than generating new loading instructions and/or stacking instructions, core logic module 330 may indicate a selection of one or more pre-defined plans for loading and/or stacking.

FIG. 3B depicts an exemplary process 360 executed when a user or scheduler initiates performance of the loading optimization logic and execution of the generated loading instructions. In the described embodiment, the user is a plant manager, and the loading optimization process 360 described with reference to FIGS. 3A and 3B is executed one or more times on a daily basis. Steps 361-365 described below are performed by or at the imitation of the plant manager and/or related personnel and/or a supporting scheduler program.

In Step 361, a number of gaylords and trucks is estimated based on the combined volume and weight of the picks (known as part of pick data 310 and/or calculated as part of a pre-processing process) associated respectively with one or more unique customers (alternatively, destinations or lanes). Depending on the method of packaging and/or product content, certain special pick types may have pre-defined business rules to handle them, which rules are taken into consideration in building gaylords and trucks. For a given customer, gaylord counts are projected by size (Full, 3Q, Half, and 1Q) and product category are projected for a user-specified gaylord mix by size. These projections may be based on considerations regarding the allowable stacking configurations of gaylords on trucks. Gaylord projections account for gaylord volume capacity limit up to a user-specified utilization level, gaylord weight capacity limit, and rules for handling special picks. In alternate embodiments, some or all of the gaylord projections may be performed by the application of one or more machine learning models (which may be, for instance, trained on historical data) by one or more neural networks. Generating projections for a number of gaylord/pallets helps to simplify the computational problem so as to efficiently run the pick-to-gaylord logic described below.

### Pick-to-Gaylord Logic

Steps 362 and 363 are performed by core logic module 330 as part of the pick-too-gaylord logic 332. In Step 362, specific picks are assigned to projected gaylords for each unique customer using rule-based heuristics. The complete feasibility of the arrangement with respect to dimensions and orientation is validated using a matheuristic algorithm in Step 363. Step 363 validates and potentially improves the pick-to-gaylord assignment generated in Step 362 using one or more optimization models (e.g., integer programming (IP) or mixed-integer programming (MIP)) to account for pick dimensions and/or orientations. The matheuristic algorithm(s) performed by pick-to-gaylord logic 332 in Steps 362 and 363 to assign picks to gaylords that considers pick dimensions and orientations is further described herein with reference to FIG. 4.

In FIG. 4, Step 410 (conforming to Step 362 in FIG. 3B) is an input step in which a pick-to-gaylord assignment (that is, assignment of pick placement positions or stacking positions on the gaylord) is generated without consideration of pick dimensions and/or orientations. In the assignment process performed in Step 410, picks sharing some pre-defined data attributes, such as customer ID, are grouped together and assigned to the same gaylords, to the extent possible. For more efficient packing, the picks are sorted in descending order of volume, and large-sized gaylords are preferred over smaller ones. Picks are assigned to gaylords up to a user-specified utilization level by volume that depends on the pick type (pallet pick, case pick, or each pick). The weight capacity of the gaylord is respected, although this is usually not a binding constraint. There may be rules forbidding the intermixing of certain special product categories with other products in the same gaylord, and these picks are handled accordingly. Picks having some prespecified attributes and large volume so that they cannot be accommodated in a single gaylord may be split into smaller picks based on a set of operating rules that ensure that a significant proportion of the pick is allocated to any gaylord to which it is assigned. A small percentage of picks, whole or fractional, that are left unassigned may be aggregated and assigned to the remaining space in the projected gaylords, and/or it may be left to the planners on the ground to assign them. It will be understood that any rules described above or otherwise herein are merely exemplary, and any practical rules may be assigned in advance (e.g., by the plant manager or company) for the application of the load optimization logic.

The pick-to-gaylord assignment in performed in Step 410 may result in a configuration that is not practically feasible to execute after accounting for specific dimensions and orientations. The complete feasibility of the arrangement with respect to dimensions and orientation is validated using a matheuristic algorithm in Step 420 (conforming to Step 363 in FIG. 3B).

In Step 420, algorithms 422 and 424 iteratively call one or more integer programming optimization models to build 2D layers of picks that determine an optimized arrangement and orientations of picks within the layer, while ensuring that there is no overlap. In Step 422, a 2D layer of picks is built from the remaining unassigned picks (considered pick data 314), accounting for pick dimensions and orientations.

While the terms 2D, 2 (two)-dimensional, plane, or planar may be used herein, it will be generally understood that these terms are being applied to a real world space and are meant to reflect a single layer within the 3-dimensional space. A layer may be understood to conform to a single tier of a stack (the stack being, e.g., the total items on a gaylord or pallet), or an analogous physical space or structure. Accordingly, a 2-D layer will have a length, width, and height, the height sufficient to accommodate the height of at least one assigned pick. In an exemplary embodiment, a 2D layer has a fixed height. That fixed height may be pre-defined or may additionally or alternately be defined by the dimensions of the pick inventory. In some embodiments, the layers may have an identical height (whether predetermined or not), and in other embodiments, the heights of various 2D layers may differ from each other, either in accordance with preset values, or as calculated in Step 420 in accordance with the dimensions of the pick inventory.

Each 2D layer of picks, as determined by the model, can have several copies that have the same product composition by pick count, noting that the dimensions are fixed for each product family. After a layer is built, there is additional logic to add more picks to the layer if such addition does not impact the overall height of the layer beyond a user-defined threshold limit (pre-assigned or assigned in real-time). The number of layer copies is determined based on pick composition of the layer and picks left to be assigned.

In Step 424, pick assignment status is updated, and the considered pick data 314 is updated/reset, such that the number of unassigned picks by product category may be changed based on the composition of layers built to this point. After all (or all possible or practicable) unassigned picks have been assigned to a layer, and based on the results of the validation, a pick-to-gaylord assignment is output (Step 430). This assignment may remain unchanged from Step 362 or may be updated so as to result in a different gaylord size.

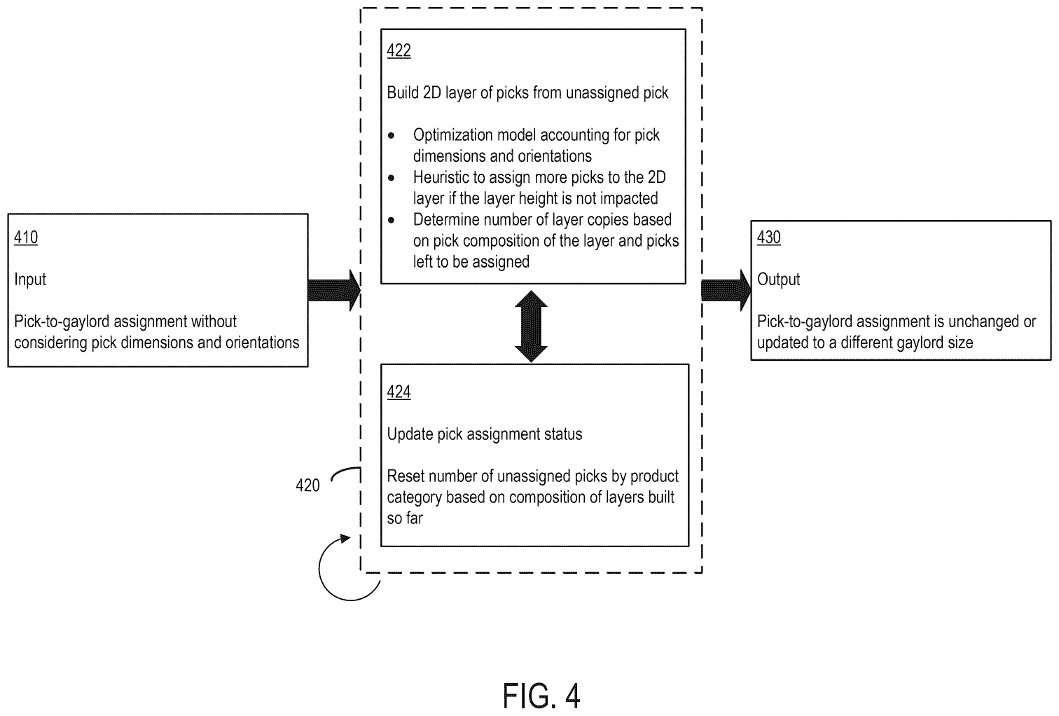

In Step 420, one or more models may be applied to build a 2D layer(s) of picks or items. In an exemplary embodiment, all items are assumed to be cuboidal in shape and have two possible orientations in the xy plane, as shown in FIGS. 5A and 5B, which illustrate two possible orientations for a cuboidal item with a fixed vertical axis. It is noted, however, that implementations are possible where items are not cuboidal in shape but are nonetheless stackable in 3-dimensions (e.g., triangular or hexagonal or other shapes that may be tiled together), so long as there is a measurable height, weight, and depth in a real space, and, to the extent possible, stackability and any stackability constraints can be determined.

The grid points for placing items on the 2D plane are constructed by taking a union of the linear combinations of a subset of small product SKUs. This method of grid construction provides a trade-off between computational complexity and solution accuracy, as compared with uniform grid size. For symmetry and avoiding gaps, grid points are defined from both ends, converging at the center of each axis.

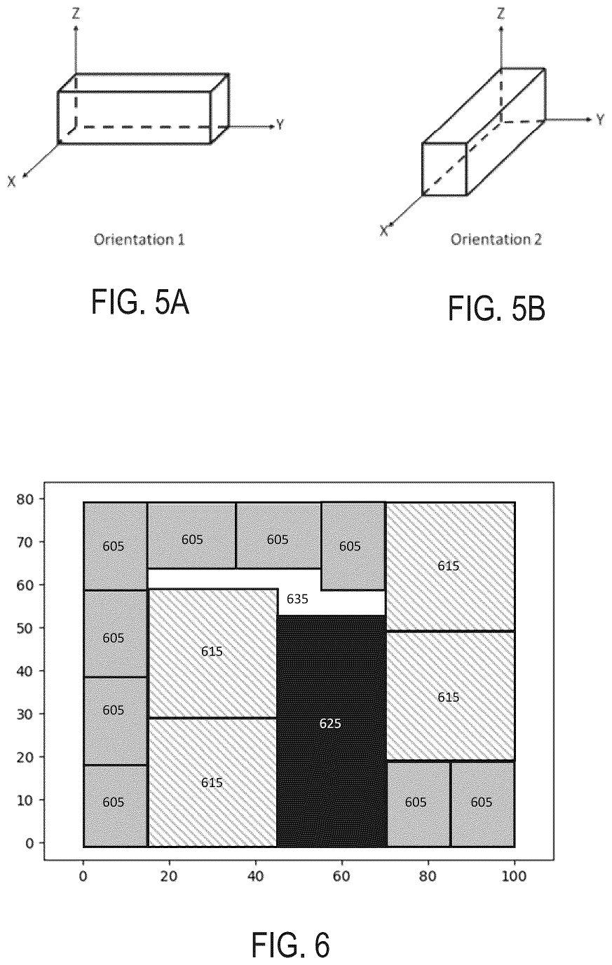

FIG. 6 depicts an example of a 2-dimensional layer within a 3-dimensional space. In FIG. 6, each of the items labeled with a common number (605, 615, 625) is associated with a common SKU. White space 635 is empty (void space) where no picks are placed in the generated assignment (but unassigned picks may be later placed). The assigned placement positions within a 2D layer may be transmitted to the user as a spreadsheet or report or a set of data, and in some embodiments, may additionally or alternately be transmitted in a graphical format.

### Example of Pick-to-Gaylord Logic

Table 1 provides variables to be used in a description of an exemplary application of pick-to-gaylord logic 332:

TABLE 1

| Variable | Description |
|---|---|
| K | Set of pick product SKUs |
| P | Set of x grid coordinates for placing items (picks) along length of gaylord |
| Q | Set of y grid coordinates for placing items (picks) along width of gaylord |
| R₁ₖ | Set of points p, q that respect the gaylord boundary conditions when items of product |
| | SKU k ∈ K are placed in orientation 1 (i.e., {L − aₖ ≥ χₚ} and {W − bₖ ≥ ψ_{q}}, where (χₚ, |
| | ψ_{q}) are the coordinates of points p ∈ P, q ∈ Q in the 2D layer grid) |
| R₂ₖ | Set of points p, q that respect the gaylord boundary conditions when items of product |
| | SKU k ∈ K are placed in orientation 2 (i.e., {L − bₖ ≥ χₚ} and {W − aₖ ≥ ψ_{q}}) |
| P₁(p, k) | Set of points r ∈ P such that when items of product SKU k ∈ K are positioned in |
| | orientation 1 at r ∈ P, they cover point p ∈ P (i.e., χₚ − aₖ < χᵣ ≤ χₚ) |
| Q₁(q, k) | Set of points s ∈ Q such that when items of product SKU k ∈ K are positioned in |
| | orientation 1 at s ∈ Q, they cover point q ∈ Q (i.e., ψ_{q} − bₖ < ψₛ ≤ ψ_{q}) |
| P₂(p, k) | Set of points r ∈ P such that when items of product SKU k ∈ K are positioned in |
| | orientation 2 at r ∈ P, they cover point p ∈ P (i.e., χₚ − bₖ < χᵣ ≤ χₚ) |
| Q₂(q, k) | Set of points s ∈ Q such that when items of product SKU k ∈ K are positioned in |
| | orientation 2 at s ∈ Q, they cover point q ∈ Q (i.e., ψ_{q} − aₖ < ψₛ ≤ ψ_{q}) |
| K_{symm} | Set of product SKUs that are symmetric in shape (i.e., aₖ − bₖ) |

The objective of this logic is to maximize the number of cases placed in a 2D layer, weighted by the area coverage of the items. The area coverage is controlled by a tunable parameter β, whose value determines the relative trade-off between the count of items and the area coverage of the placed items on the 2D layer. Mathematically, the objective is expressed in Formula 1 below, where aₖ is the length of pick case of product SKU k∈K, bₖ is the width of pick case of product SKU k∈K, x_{kpq} is a binary decision variable that equals one if item SKU k∈K is placed at points (p, q) in first orientation ∀ (p, q)∈R1k (zero otherwise), and y_{kpq} is a binary decision variable that equals one if item SKU k∈K−K_{symm} is placed at points (p, q) in second orientation ∀ (p, q)∈R₂ₖ (zero otherwise).

$$max {\sum }_{k ∈ K} {( {a}_{k} {b}_{k} )}^{β} {\sum }_{p ϵ P} {\sum }_{q ϵ Q} ( {x}_{k p q} + {y}_{k p q} ) \qquad Formula 1$$

The binary decision variables are defined as follows:

$${x}_{kpq} ∈ \{ 0 ; 1 \} ∀ ( p , q ) ∈ {R}_{1 k} , ∀ k ∈ K ,$$

$${y}_{k p q} ∈ \{ 0 ; 1 \} ∀ ( p , q ) ∈ {R}_{2 k} , ∀ k ∈ K - {K}_{symm}$$

When there are significant disparities in item heights, the weights in the objective function can alternatively be expressed as a function of the item heights by Formula 2, where hₖ is the height of pick case of product SKU k∈K and β is the prioritizing parameter (tunable).

$$max {\sum }_{k ∈ K} {( {h}_{k} )}^{β} {\sum }_{p ϵ P} {\sum }_{q ϵ Q} ( {x}_{k p q} + {y}_{k p q} ) \qquad Formula 2$$

The number of cases assigned may be constrained so as not to exceed the available number of cases for each product SKU. The number of cases assigned is represented by Formula 3, where Nₖ is the number of cases available to be packed within gaylord of product SKU k∈K.

$${\sum }_{p ϵ P} {\sum }_{q ϵ Q} ( {x}_{k p q} + {y}_{k p q} ) \leq {N}_{k} , ∀ k ∈ K \qquad Formula 3$$

All pairs of items should be completely non-overlapping in both X and Y directions on the 2D plane. This is implemented by a constraint represented by Formula 4.

$${\sum }_{k ϵ K} ( {\sum }_{r ∈ {P}_{1} ( p , k )} {\sum }_{s ∈ {Q}_{1} ( q , k )} {x}_{k r s} + {\sum }_{r ∈ {P}_{2} ( p , k )} {\sum }_{s ∈ {Q}_{2} ( q , k )} {y}_{k r s} ) \leq 1 , \qquad Formula 4$$

$$∀ p ∈ P , ∀ q ∈ Q$$

It will be noted that all decision variables defined herein ensure that the items placed in the 2D layer do not extend beyond the boundaries of the gaylord. To break symmetry for square-shaped product SKUs, one set of corresponding variables, y_{kpq}, is eliminated from the model.

Other embodiments may additionally or alternatively use methodology such as parallelized search-based metaheuristics, quantum computing, and reinforcement learning, to accelerate solutions for larger markets and higher shipment volumes.

### Gaylord-to-Truck Logic

Based on the updated recommendations output in Step 363, the loading instructions for assigning picks to gaylords are generated and executed in Step 364 by the loading planners in the warehouse/loading facility. After the completion of Step 364, the gaylords built on the floor are staged for loading onto the trucks. In Step 365, an integer programming optimization model is used (gaylord-to-truck logic 334 in core logic module 330) to determine the optimal or nearing optimal stacking of gaylords on trucks that seeks to minimize the number of stacking positions in the truck, while respecting a set of technical and operational constraints. In the exemplary embodiment, such constraints may include stacking layout of the truck, priority rules for different gaylord stacking configurations, truck weight capacity, and other stacking constraints related to gaylord product contents, gaylord weight, and gaylord height. It will however be understood that any constraints described above or otherwise herein are merely exemplary, and any constraints may be assigned in advance or in real-time (e.g., by the plant manager) for the application of the stacking optimization.

### Example of Gaylord-to-Truck Logic

An exemplary matheuristic algorithm(s) performed by gaylord-to-truck logic 334 to assign gaylord-to-truck stacking is described herein. In this example, gaylords are built and staged for loading on trucks, an optimal or nearing optimal stacking of gaylords on trucks is determined such that up to three trucks are optimized in a single run. Table 2 provides sets of data to be used in an exemplary application of gaylord-to-truck logic:

TABLE 2

| Variable | Description |
|---|---|
| I | Set of gaylords to be stacked |
| J | Set of positions in the truck where gaylords can be stacked |
| L | Set of stacking layers at each position |

The binary decision variables are defined as follows, where yⱼ is the binary decision variable equals one if truck position j∈J is occupied (zero otherwise).

$${x}_{ijl} ∈ \{ 0 , 1 \} ∀ i ∈ I , ∀ j ∈ J , ∀ l ∈ L$$

$${y}_{j} ∈ \{ 0 , 1 \} ∀ j ∈ J$$

The optimization objective of the model is to minimize the number of gaylord stacks or positions occupied in the truck. The number of gaylord stacks or positions is represented by Formula 5, where yⱼ is the binary decision variable equals one if truck position j∈J is occupied (zero otherwise).

$$min {\sum }_{j ∈ J} {y}_{j} \qquad Formula 5$$

Each gaylord is assigned to a unique truck position and layer. This constraint is represented by Formula 6, where x_{ijI} is the binary decision variable equals one if gaylord i∈I is placed in layer l∈L at position j∈J (zero otherwise).

$${\sum }_{j ϵ J} {\sum }_{l ϵ L} {x}_{i j l} = 1 ∀ i ∈ I \qquad Formula 6$$

A truck position is occupied if one or more gaylords are assigned to it. This constraint is represented by Formula 7.

$${\sum }_{i ϵ I} {x}_{i j 0} \leq {y}_{i} ∀ j ∈ J \qquad Formula 7$$

A given position and layer in the trucking layout can accommodate at most one gaylord. This constraint is represented by Formula 8.

$${\sum }_{i ϵ I} {x}_{i j l} \leq 1 ∀ j ∈ J , ∀ l ∈ L \qquad Formula 8$$

The total height of the stacked gaylords in any position should not exceed the effective height of the truck, including the height of the pallet on which the gaylords are stacked and the safety clearance from the roof of the truck. The total height of the stacked gaylords is represented by Formula 9, where H is the effective height of truck accounting for pallet height and clearance and hᵢ is the height of gaylord i∈L.

$${\sum }_{i ϵ I} {\sum }_{l ϵ L} {h}_{i} {x}_{i j l} \leq H ∀ j ∈ J \qquad Formula 9$$

At any truck position, each gaylord must be supported by a gaylord in the layer below it (or by the truck floor). This constraint is represented by Formula 10.

$${\sum }_{i ϵ I} {x}_{i j l} \geq {\sum }_{i ϵ I} {x}_{i j ( l + 1 )} ∀ j ∈ J , ∀ l ∈ L / {L}_{max} \qquad Formula 10$$

The weight of a gaylord must be lower than the weight of the gaylord on which it is stacked. This constraint is represented by Formula 11, where wᵢ is the weight of gaylord i∈L

$${\sum }_{i ϵ I} {w}_{i} {x}_{i j l} \geq {\sum }_{i ϵ I} {w}_{i} {x}_{i j ( l + 1 )} ∀ j ∈ J , ∀ l ∈ L / {L}_{max} \qquad Formula 11$$

Gaylords belonging to certain special product categories cannot have gaylords stacked on top of them. This constraint is represented by Formula 12, where αᵢ is the binary parameter equals one if gaylord i∈I belongs to special product category with restrictions on stacking.

$${\sum }_{i ϵ I} {a}_{i} {x}_{i j l} + {\sum }_{i ϵ I} {x}_{i j ( l + 1 )} \leq 1 ∀ j ∈ J , ∀ l ∈ L / {L}_{max} \qquad Formula 12$$

The above model returns an optimal or nearing optimal stacking configuration of gaylords that are then assigned to trucks such that the weight capacity of the truck is not violated, although this is almost never a binding constraint.

Other embodiments may additionally or alternatively use methodology such as parallelized search-based metaheuristics, quantum computing, and reinforcement learning, to accelerate solutions for larger markets and higher shipment volumes.

Conventional processes for cost-effective container loading and shipping may require holding orders over multiple deliveries for consolidation to maximize pallet utilization, which is not practical due to a need for fast delivery of product and the possibility of inventory buildup, among other things. The systems and methods described above with reference to FIGS. 1-7 reduce such concerns as each model run captures all—and is limited to only those—orders planned for same-date departure by the warehouse management system. These systems and methods provide a highly-scalable automated platform for data ingestion. The methods described herein may be executed multiple times per day for each deployed lane, providing guidance for daily operational planning for building gaylords from order line picks to truck loading. This leads to the creation of systematic and efficient load plans, resulting in cost savings per container shipped, faster shipment of orders, and CO₂ emissions reduction benefits.

The disclosure includes the listed embodiments and the text and drawings appended hereto as well as any cited documents, which are incorporated by reference herein in their entirety. The description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible non-transitory computer readable storage medium or any type of media suitable for storing electronic instructions and coupled to a computer system bus. Furthermore, any computing systems referred to in the specification may include a single processor or may be architectures employing multiple processor designs for increased computing capability.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations. The one or more processors may also operate to support performance of the relevant operations in a “cloud computing” environment or as a “software as a service” (SaaS) or located in a single geographic location (e.g., within a home environment, an office environment, or a server farm). For example, at least some of the operations may be performed by a group of computers (as examples of machines including processors), these operations being accessible via a network (e.g., the Internet) and via one or more appropriate interfaces (e.g., application program interfaces (APIs).)

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Finally, the language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention, which is set forth in the following claims.

1. A method of determining respective placements for a plurality of objects within a 3-dimensional physical space, the method comprising:
obtaining, for each of the plurality of objects, (a) a height, (b) a weight, and (c) an indication of whether the object may be stacked;
assigning one or more objects of the plurality of objects for placement within a 2-dimensional layer having a fixed height; and
assigning, via one or more mathematical calculations, a placement position within the 2-dimensional layer for each of the one or more objects of the plurality of objects, the one or more mathematical calculations being configured to:
(i) maximize the number of objects of the plurality of objects than can be placed within the 2-dimensional layer, weighted by the area of the objects, and
(ii) if the height of the objects with assigned placement positions is less than the fixed height, select additional unassigned objects of the plurality of objects for placement within the 2-dimensional layer and assign, for each additional unassigned object, a placement position within the 2-dimensional layer.

2. The method of claim 1, wherein the 3-dimensional physical space is a gaylord.

3. The method of claim 1, wherein, for an object of the plurality of objects, one or more of the height, the weight, and the indication of whether the object may be stacked is determined based on one or more of the following: a product category, a product type, a stock keeping unit (SKU), and a universal product code (UPC).

4. The method of claim 1, wherein the one or more objects of the plurality of objects are cuboid in shape.

5. The method of claim 1, wherein, for an object of the plurality of objects, one or more of the height, the weight, and the indication of whether the object may be stacked is determined based on data obtained, via a data pipeline, from one or more warehouse management systems.

6. The method of claim 5, wherein the data pipeline is dedicated to the transfer of data relating to the plurality of objects, and
wherein the data relating to the plurality of objects comprises one or more of the following: product category, product type, stock keeping unit (SKU), and universal product code (UPC).

7. The method of claim 1, further comprising displaying the assigned placement positions to a user via a screen or a report.

8. A method of determining respective placements for each of a plurality of objects within a 3-dimensional container space, the method comprising:
obtaining, for each of the plurality of objects, (a) a height, (b) a weight, and (c) an indication of whether the object may be stacked;
defining, within the three-dimensional container space, a plurality of positions;
for each of the plurality of positions, assigning one or more objects of a plurality of objects for placement at the position using one or more heuristic algorithms configured to maximize the number of objects of the plurality of objects than can be placed within the 3-dimensional container space weighted by the area of the objects.

9. The method of claim 8, wherein at least one of plurality of objects is a gaylord.

10. The method of claim 8, wherein the 3-dimensional container space is the cargo space of a truck.

11. The method of claim 8, wherein the 3-dimensional container space has a fixed height.

12. The method of claim 8, wherein the 3-dimensional container space is defined by a coordinate grid.

13. The method of claim 12, wherein each of the plurality of positions comprises at least one set of coordinates defining a discrete 3-dimensional space within a cargo space of a truck.

14. A method for projecting, based on a plurality of objects, a number of physical containers needed to transport the plurality of objects, the method comprising:
determining an arrangement of the plurality of objects to be placed within or upon one or more physical containers, each physical container having a fixed height, wherein the determining comprises iteratively performing the following steps until all objects of the plurality of objects have been assigned to a stacking position within the one or more physical containers:
(a) selecting, in accordance with one or more integer programming optimization models and/or heuristic functions, whether additional objects should be added to a first physical container of the one or more physical containers or to another physical container of the one or more physical containers, and
(b) assigning each object of a subset of the plurality of objects, in accordance with the selecting, a stacking position within or upon a physical container, wherein the assigning is performed by applying one or more integer programming optimization models and/or heuristic functions that account for one or more of: a pick dimension, a pick orientation, a pick height, a pick weight, a pick categorization; and
generating, based on the determined arrangement of the plurality of objects, one or more virtual loading plans for at least one of the one or more physical containers.

15. The method of claim 14, wherein the physical containers are gaylords and wherein the method further comprises:
determining, based on the one or more virtual loading plans, a number of gaylords needed to transport the plurality of objects.

16. The method of claim 14, wherein the method further comprises:
determining, based on the one or more virtual loading plans, a number of trucks needed to transport the plurality of objects.

17. The method of claim 14, wherein the arrangement of the plurality of objects is further determined in accordance with, for each object of the plurality of objects: a product volume, a product weight, and/or a determination of whether the product has a product type to which one or more specialized rules must be applied.

18. The method of claim 14, wherein the arrangement of the plurality of objects is further determined to minimize the number of total stacking positions.

19. The method of claim 14, wherein the physical containers are trucks, and
wherein the method further comprises:
projecting a number of trucks needed to transport the plurality objects in accordance with one or more of: an object volume, an object weight, and special restrictions on the objects.

20. The method of claim 14, wherein the physical containers are gaylords, and
wherein the method further comprises:
projecting a number of trucks needed to transport the gaylords in accordance with one or more of: gaylord height, gaylord weight, stacking rules related to objects placed within or upon the gaylord.
